(19) United States
(12) Patent Application Publication
(10) Pub. No.: US 2006/0213828 A1
(43) Pub. Date: Sep. 28, 2006

(54) Filter having mutually interacted filter housing and filter cartridge

(76) Inventor: Chuan Chin Shen, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/086,453

(22) Filed: Mar. 23, 2005

(51) Int. Cl. B01D 35/28

(52) U.S. Cl. 210/451; 210/455; 210/497.01

(57) ABSTRACT

The present invention relates to a filter having a filter housing and a filter cartridge mutually interacted with one another. The present invention is to provide the filter with the mutually interacted filter housing and filter cartridge. When the filter housing is loosened from a base, the filter housing and the filter cartridge are pulled out together so as to provide the convenience of replacing the filter cartridge.

### FIELD OF THE INVENTION

The present invention relates to a filter having mutually interacted filter housing and filter cartridge, and more particularly to a filter housing and a filer cartridge having corresponding structures.

### BACKGROUND OF THE INVENTION

With the promotion of the life quality, the boiling method for disinfecting the drinking water before drinking is gradually replaced by various purifiers. Every purifier mentioned above must equip with a filter since the filtration is basically essential for purifying water.

In order to protect the key structures, the aforementioned filter comprises a filter housing and a filter cartridge, wherein the filter housing protects the filter cartridge. The filter housing has a closed end and an open end, and the filter cartridge has a first end and a second end. The filter housing and the filter cartridge are coupled with one another from outside and inside respectively. The filter housing is then locked on a base by means of the open end. In the meantime, the filter cartridge is also locked on the base in a homocentric manner.

However, if the user wants to replace the filter cartridge, the filter housing must be loosened from the base by rotation first. Next, the filter cartridge is pulled out of the base. In that case, the disassembly of the filter must perform at least two rotation and loosening steps so it is too complicated. Besides, the base always has the small space that confines force exertion and movement so it is not easy for the user to replace the filter cartridge. Accordingly, the desire of the user for replacing the filter cartridge is decreased, and therefore the heath of the user is worsened.

### SUMMARY OF THE INVENTION

In view of the aforementioned problems of the prior art, the present inventor provides a filter with improved structures. The filter comprises a filter housing and a filter cartridge, wherein the filter housing has a closed end and an open end, and the filter cartridge has a first end and a second end. The filter housing and the filter cartridge are coupled with one another from outside and inside respectively. The present invention further comprises at least an oppositely extended wall on the inside of the closed end of the filter housing; at least a flat step on the outside of the first end of the filter cartridge; a stopper adjacent to the flat step, wherein a gap having a width larger than a thickness of the oppositely extended wall is defined between the stopper and the flat step. The oppositely extended wall of the filter housing is such located to axially correspond to the flat step of the filter cartridge that a rotation causes the oppositely extended wall to be screwed into the gap. Accordingly, the filter housing and the filter cartridge are pulled out together by obstruction caused by the stopper when the filter housing is loosened from a base by another rotation.

### BRIEF DESCRIPTION OF THE DRAWINGS

FIG. 1 is an elevational view showing the outward appearance of a preferred embodiment of the present invention.

FIG. 2 is an elevational exploded view showing the outward appearance of the preferred embodiment of the present invention.

FIG. 3 is a cross-sectional top view showing that the oppositely extended wall is located to correspond to the flat step in accordance with the present invention.

FIG. 4 is a cross-sectional top view showing that the oppositely extended wall is screwed into the gap in accordance with the present invention.

FIG. 5 is an elevational view of the outward appearance of the present invention, which shows that the filter is coupled with the base for use.

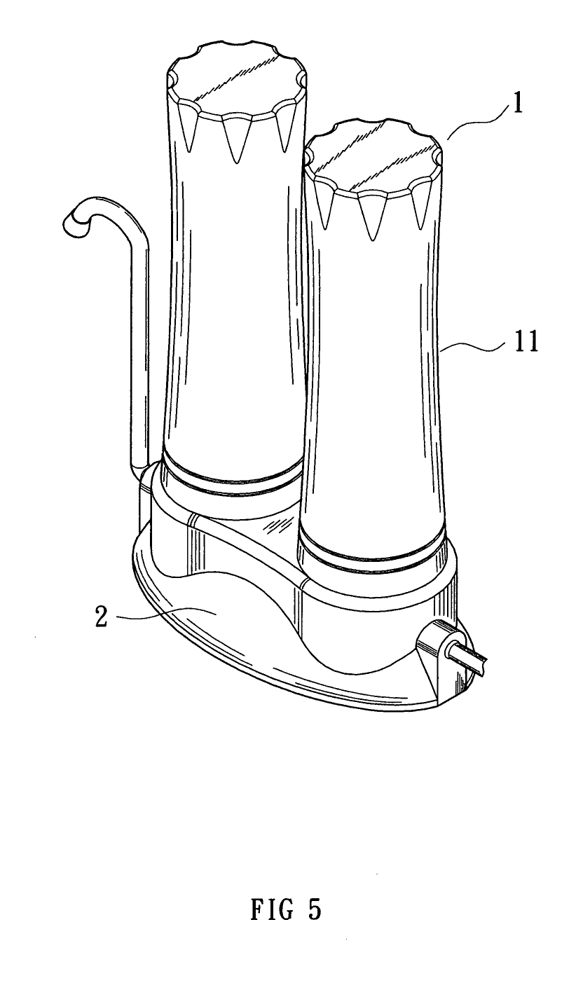

FIG. 6 is an elevational exploded view showing the mounting of the oppositely extended wall and the filter housing in accordance with another preferred embodiment of the present invention.

### DETAILED DESCRIPTION OF THE PREFERRED EMBODIMENT

The description taken with the drawings make the structures, features, and embodiments of the present invention apparent to Examiner how the present invention may be embodied in practice.

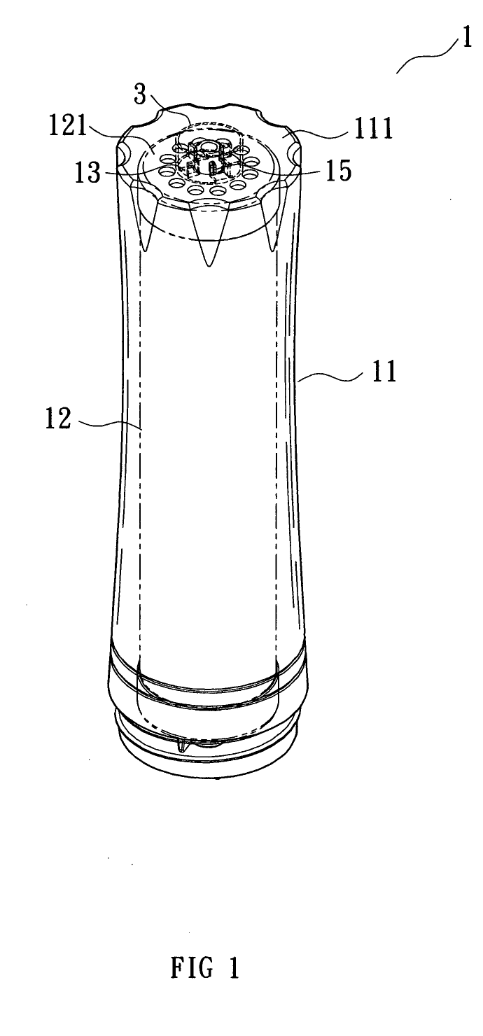

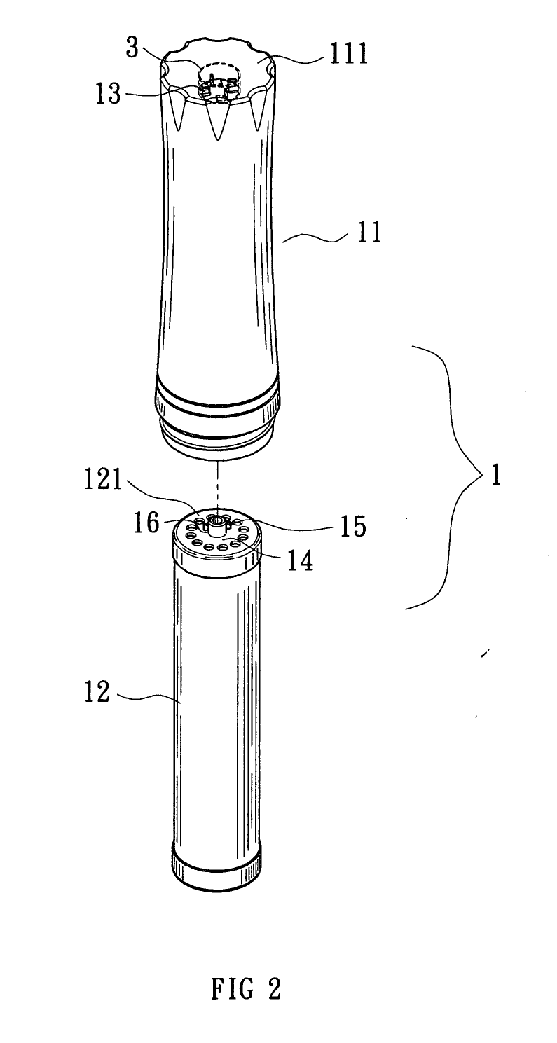

Referring to FIG. 1 and FIG. 2, the present inventor pertains to a filter housing and a filter cartridge of a filter, which mutually interact with one another. The filter 1 comprises: a filter housing 11 having a closed end 111 and an open end (not shown); and a filter cartridge 12 having a first end 121 and a second end (not shown).

At least an oppositely extended wall 13 is mounted on the inside of the filter housing 11. If the oppositely extended wall 13 is mounted inside the closed end 111 of the filter housing 11, it can be located inside a ring 3 and injection molded to integrate with the ring 3 and the filter housing 11. At least a flat step 14 is formed on the outside of the first end 121 of the filter cartridge 12, and a stopper 15 is formed adjacent to the flat step 14, wherein a gap 16 having a width larger than a thickness of the oppositely extended wall 13 is defined between the stopper 15 and the flat step 14.

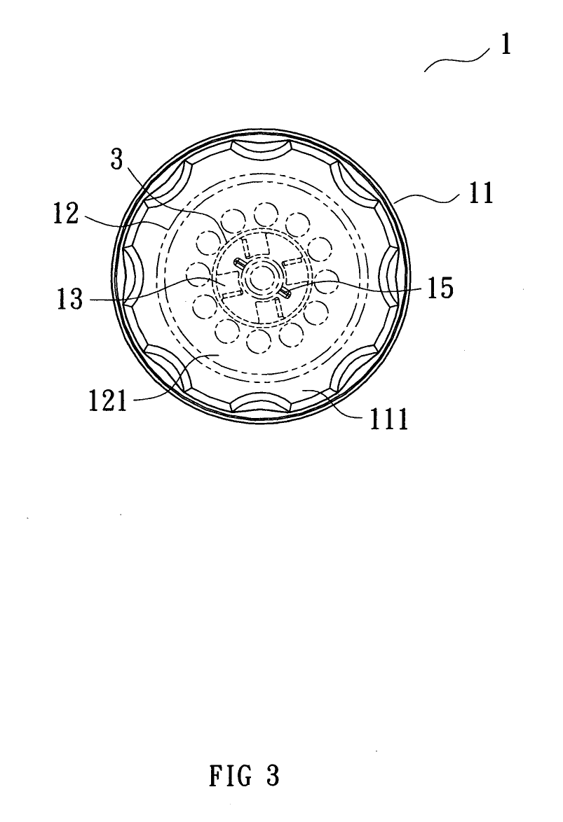

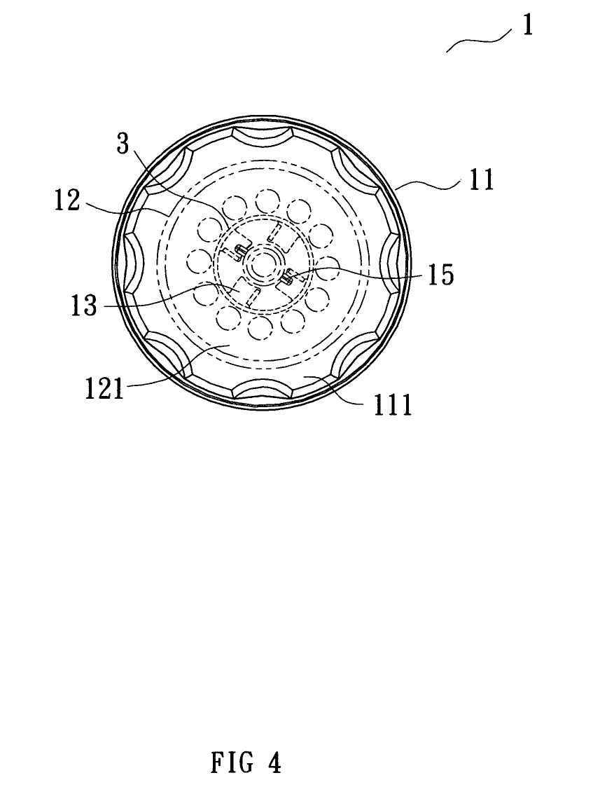

Referring to FIG. 3 and FIG. 4, the oppositely extended wall 13 of the filter housing 11 is such located to axially correspond to the flat step 14 of the filter cartridge 12 that the rotation causes the oppositely extended wall 13 to be screwed into the gap 16. When the filter housing 11 is loosened from a base 2 by another rotation, the filter housing 11 and the filter cartridge 12 are pulled out together by obstruction caused by the stopper 15.

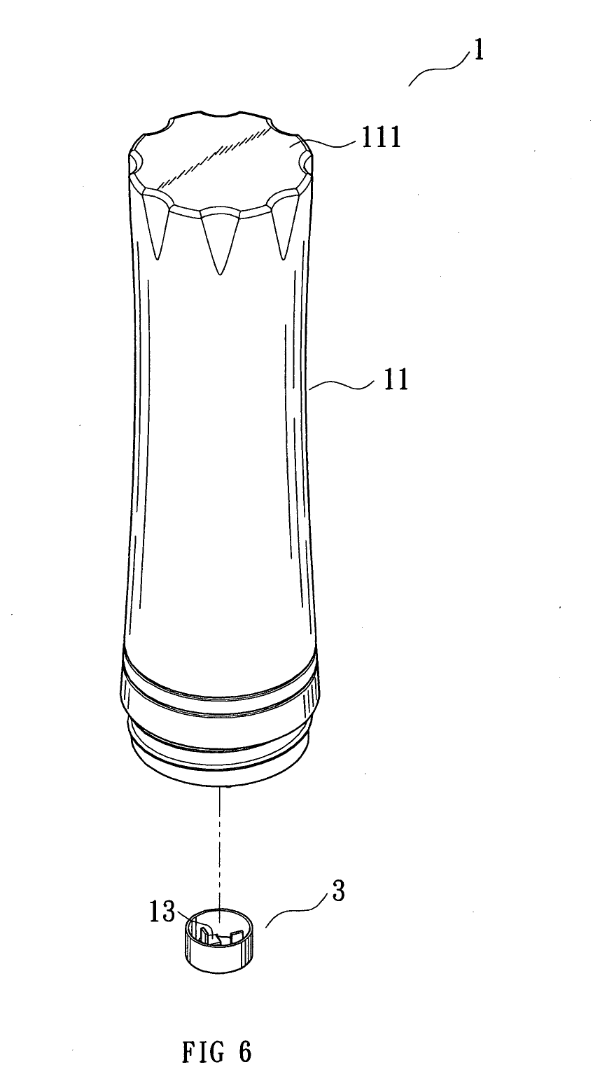

It is worthy to note that the oppositely extended wall of the present invention indicates that it is oppositely extended from the inside of the closed end of the filter housing. In addition to the aforementioned preferred embodiment having the oppositely extended wall molded to integrate with the inside of the closed end of the filter housing, an alternative preferred embodiment having the oppositely extended wall 13 on an independently mounted ring 3 is further shown in FIG. 6, The independently mounted ring 3 is then coupled with the inside of the closed end 111 of the filter housing 11. The foregoing description pertains to the preferred embodiments of the present invention. Nevertheless, the present invention further comprises a thinkable modification of reversely exchanging the oppositely extended wall of the filter housing and the flat step of the filter cartridge with one another.

Efficacy and Advantage of the Present Invention

The filter of the present invention includes a filter housing and a filter cartridge mutually interacted with one another, wherein the oppositely extended wall of the filter housing is such located to axially correspond to the flat step that the rotation causes the oppositely extended wall to be screwed into the gap. When the filter housing is loosened from the base by another rotation, the filter cartridge and the filter housing are pulled out together by obstruction caused by the stopper. It is helpful to the user so he can conveniently replace the filter cartridge. Accordingly, the desire of the user for replacing the filter cartridge is increased, and therefore the heath of the user is improved.

On the basis of the description mentioned above, the present invention indeed satisfies requirements for patentability, and is therefore submitted for a patent.

With the invention thus explained, it is apparent that various modifications and variations can be made without departing from the scope of the invention. It is therefore intended that the invention be limited only as indicated in the appended

What the invention claimed is:

1. A filter having a filter housing and a filter cartridge, said filter housing having a closed end and an open end, and said filter cartridge having a first end and a second end, said filter housing and said filter cartridge being coupled with one another from outside and inside respectively, characterized in that:
at least an oppositely extended wall is mounted on the inside of said closed end of said filter housing;
at least a flat step is formed on the outside of said first end of said filter cartridge; and
a stopper is formed adjacent to said flat step, wherein a gap having, a width larger than a thickness of said oppositely extended wall is defined between said stopper and said flat step, said oppositely extended wall of said filter housing is such located to axially correspond to said flat step of said filter cartridge that a rotation causes said oppositely extended wall to be screwed into said gap so said filter housing and said filter cartridge are pulled out together by obstruction caused by said stopper when said filter housing is loosened from a base by another rotation.

2. The filter of claim 1, wherein said oppositely extended wall is molded to integrate with the inside of said closed end of said filter housing.

3. The filter of claim 2, wherein said oppositely extended wall on the inside of said closed end of said filter housing is mounted in a ring and injection molded to integrate with said ring and said filter housing.

4. The filter of claim 1, wherein said oppositely extended wall is mounted on an independently mounted ring, and said independently mounted ring is coupled with the inside of said closed end of said filter housing.
